(19) United States
(12) Patent Application Publication
(10) Pub. No.: US 2010/0309086 A1
(43) Pub. Date: Dec. 9, 2010

(54) MULTIPLE-INPUT MULTIPLE-OUTPUT DEVICE

(75) Inventors: XUE-DONG JIANG, Shanghai (CN); SU-QIN LI, Shanghai (CN); JIAN-FENG XIAO, Shanghai (CN); MING-JIANG FAN, Shanghai (CN)

Correspondence Address: Altis Law Group, Inc.;ATTN: Steven Reiss, 288 SOUTH MAYO AVENUE, CITY OF INDUSTRY, CA, 91789, US

(73) Assignees: AMBIT MICROSYSTEMS (SHANGHAI) LTD., SHANGHAI (CN); HON HAI PRECISION INDUSTRY CO., LTD., Tu-Cheng (TW)

(21) Appl. No.: 12/582,792

(22) Filed: Oct. 21, 2009

(30) Foreign Application Priority Data
Jun. 5, 2009 (CN) 200920304032.5

(51) Int. Cl. H01Q 1/52

(52) U.S. Cl. 343/841

(57) ABSTRACT

A multiple-input multiple-output (MIMO) device includes a substrate, a shielding cover and a MIMO antenna. The shielding cover is positioned on the substrate, and includes a plurality of sidewalls. The MIMO antenna includes a first solid antenna, a second solid antenna, and a plane antenna. The first solid antenna and the second solid antenna are electrically connected to two ends of one sidewall of the shielding cover, respectively. The first plane antenna is configured on the substrate, and disposed between the first solid antenna and the second solid antenna.

### BACKGROUND

1. Technical Field

Embodiments of the present disclosure relate to electrical devices, and especially to a multiple-input and multiple-output (MIMO) device with a MOMO antenna.

2. Description of Related Art

MIMO antennas have attracted recent focus, due to increased throughput and transmission distance with no requirement for frequency band change or transmission power expenditure. The core value of MIMO antenna is increased transmission rate and communication quality using a plurality of antennas to send and receive electromagnetic signals.

The antenna includes inner and outer antennas. The inner antenna maintains device simple and compact in shape. However, design of an inner MIMO antenna to meet wireless device demands has proven a significant challenge in the industry.

### BRIEF DESCRIPTION OF THE DRAWINGS

FIG. 1 is a schematic diagram of one embodiment of a MIMO device according to the present disclosure;

FIG. 2 is an exploded view of the MIMO device of FIG. 1;

FIG. 3 is a local view of the MIMO device, illustrating dimensions of parts thereof;

FIG. 4 is a graph showing one exemplary return loss of the MIMO device of FIG. 1;

FIG. 5 is a schematic diagram of one embodiment of a MIMO device according to the present disclosure; and

FIG. 6 is a schematic diagram of one embodiment of the MIMO device of FIG. 1.

### DETAILED DESCRIPTION

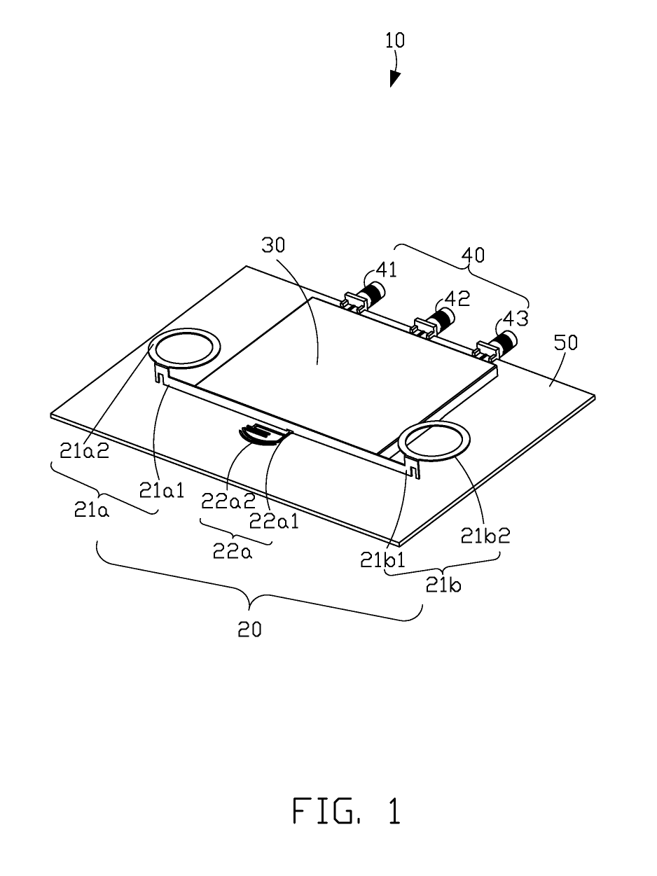

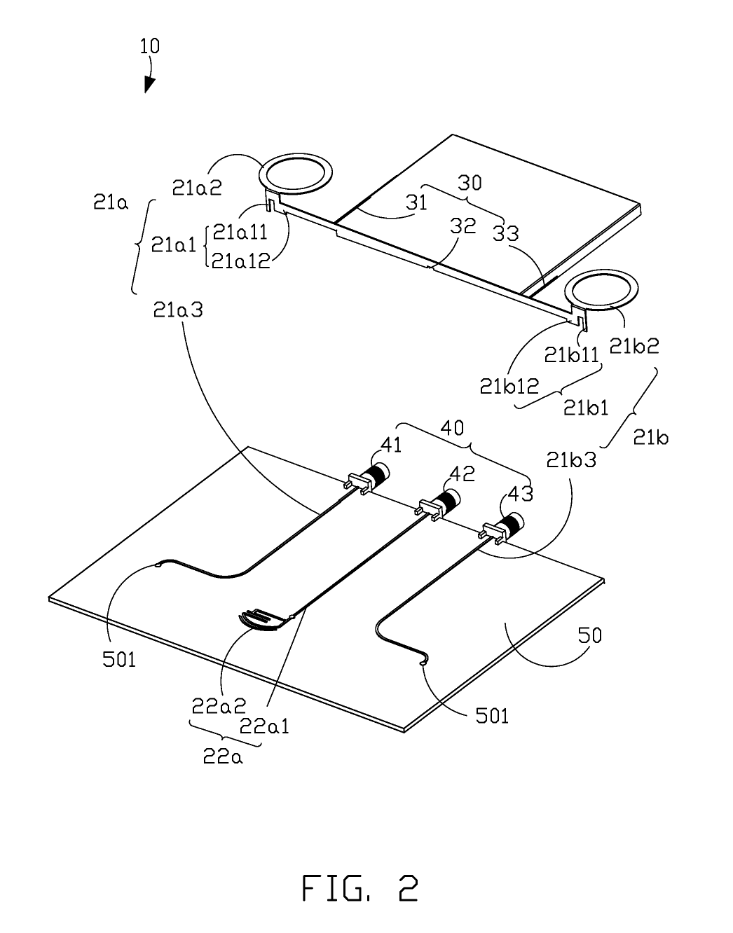

Referring to FIG. 1 and FIG. 2, one embodiment of a multi-input multi-output (MIMO) device 10 is shown. The MIMO device 10 comprises a substrate 50, a connecting portion 40, a shielding cover 30, and a MIMO antenna 20.

The substrate 50 comprises a plurality of position throughways 501, to position the shielding cover 30 and the MIMO antenna 20.

The shielding cover 30 is configured on the substrate 50, and comprises a plurality of sidewalls. In one embodiment, the shielding cover 30 is rectangular, but may have other shapes such as polygonal. The shielding cover 30 further comprises a first feed throughway 31, a second feed throughway 32, and a third feed throughway 33. The first feed throughway 31, the second throughway 32 and the third feed throughway 33 are configured on the two ends and middle portion of the one sidewall of the shielding cover 30, respectively.

The MIMO antenna 20 is configured on the substrate 50, and comprises solid antennas 21 and plane antennas 22 disposed alternatively. In one embodiment, the MIMO antenna 20 comprises a first solid antenna 21a, a second solid antenna 21b, and a first plane antenna 22a. In one embodiment, the first solid antenna 21a and the second solid antenna 21b are configured on the same side of one sidewall of the shielding cover 30, and the first plane antenna 22a is on the opposite side of one sidewall of the shielding cover 30.

In one embodiment, the first solid antenna 21a and the second solid antenna 21b are electrically connected to two ends of one sidewall of the shielding cover 30, respectively. The first plane antenna 22a is configured on the substrate 50, and disposed between the first solid antenna 21a and the second solid antenna 21b. Partial enclosure of the shielding cover 30 by the MIMO antenna 20 can reduce volume of the MIMO device 10, and increase polarization effectiveness.

The first solid antenna 21a comprises a first connection section 21a1, a first solid radiator 21a2, and a first feed line 21a3.

The first feed line 21a3 is configured on the substrate 50, passing through the first feed throughway 31, to provide electromagnetic signals.

The first connection section 21a1 comprises a first feed end 21a11 and a first short end 21a12. The first feed end 21a11 connects the first solid radiator 21a2 to the first feed line 21a3, and passes through the positioning throughway 501 to position the first solid radiator 21a2. The first short end 21a12 connects the first solid radiator 21a2 to the shielding cover 30, to ground. In one embodiment, the first solid radiator 21a2, the first feed end 21a11, and the first short end 21a12 form a planar inverted F antenna (PIFA). In one embodiment, the first connection section 21a1 is connected to one end of one sidewall of the shielding cover 30. In one embodiment, the first solid radiator 21a2 is annular, to transceive the electromagnetic signals. In other embodiments, the first solid radiator may other shapes.

The second solid antenna 21b comprises a second feed line 21b3, a second connection section 21b1 and a second solid radiator 21b2. In one embodiment, the second solid antenna 21b is substantially symmetrical about the first solid antenna 21a in shape and structure.

The first plane antenna 22a is configured on the substrate 50, and comprises a first plane radiator 22a2 and a first feed portion 22a1. In one embodiment, the first feed portion 22a1 is elongated and connected to the second feed throughway 32, to supply the electromagnetic signals. The first feed portion 22a1 is perpendicular to one sidewall of the shielding cover 30. The first plane radiator 22a2 is grounded by coupling to one sidewall of the shielding cover 30. In one embodiment, the first plane radiator 22a2 is substantially G shaped to conserve space. In other embodiments, the first plane radiator 22a2 may other shapes.

In one embodiment, the connecting portion 40 comprises a first connector 41, a second connector 42, and a third connector 43. The first connector 41, the second connector 42, and the third connector 43 are configured on another sidewall of the shielding cover 30, and connect the MIMO antenna 20 to some electronic components, such as RF module, to transmit electromagnetic signals. In one embodiment, the first connector 41, the second connector 42, and the third connector 43 are connected to the first feed line 21a3, the first feed portion 22a1, and the second feed line21b3, respectively.

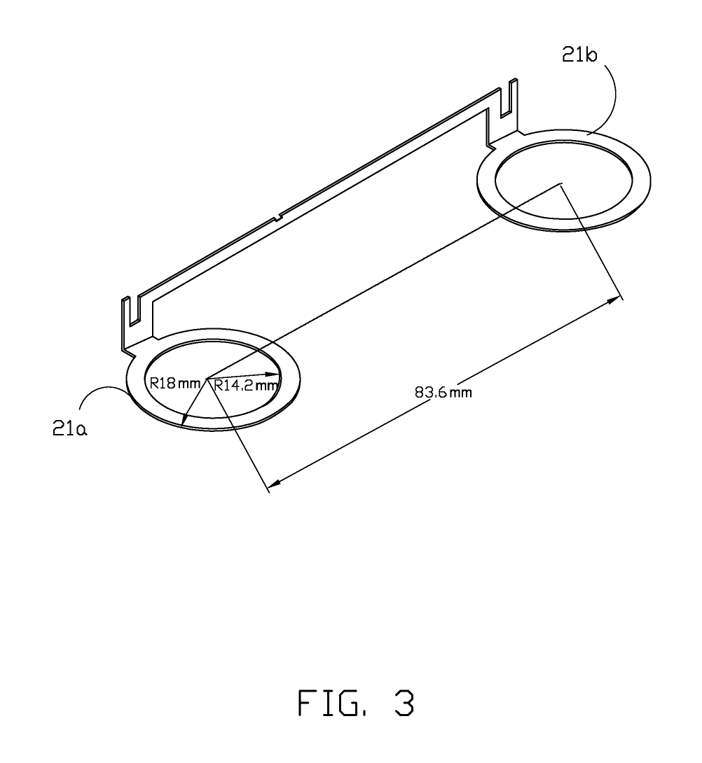

Referring to FIG. 3, a local view and dimensions of parts of MIMO device 10 is shown. An inner radius and an outer radius of the first solid radiator 21a2 are approximately 14.2 mm and 18 mm, respectively. A distance between a center of the first radiator 21a and a center of the second radiator 21b is approximately 83.6 mm. It should be understood that the values disclosed above are exemplary and may differ depending on the embodiment.

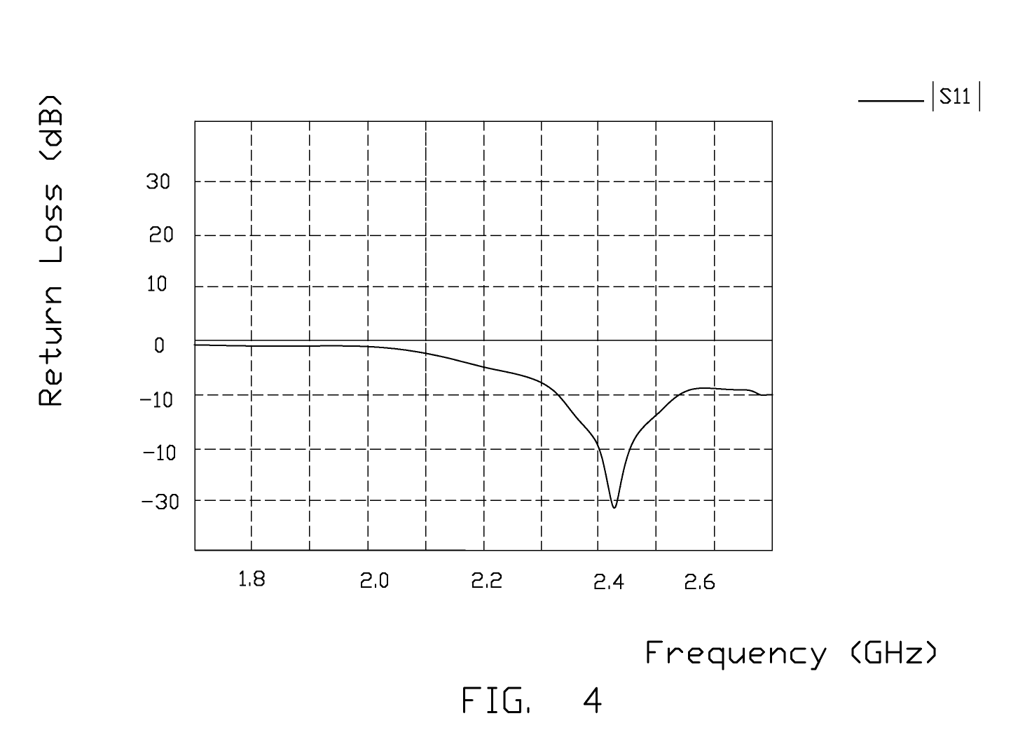

FIG. 4 is a graph showing exemplary return loss of the MIMO device 10 of FIG. 1. As shown, the return loss is less than −10 dB, when the MIMO device 10 works in frequency bands from 2.4 GHZ to 2.5 GHz.

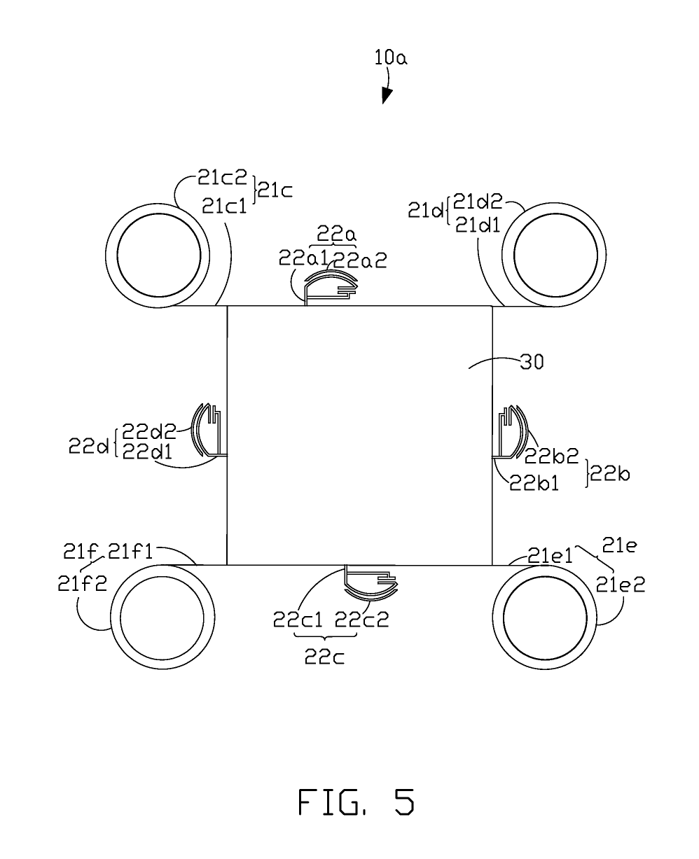

FIG. 5 is a schematic diagram of one embodiment of a MIMO device 10a according to the present disclosure, differing from the MIMO device 10 shown in FIG. 1 only in the further inclusion of a third solid antenna 21e and a fourth antenna 21f, and a plurality of plane antennas, such as 22b, 22c and 22d.

In one embodiment, the first solid antenna 21c and the second solid antenna 21d and the first plane antenna 22a are configured on the same sidewall of the shielding cover 30. The third solid antenna 21e, the fourth solid antenna 21f and one of the plurality of plane antennas 22c are connected to two ends of another sidewall of the shielding cover 30, respectively.

As shown in FIG. 2 and FIG. 5, the third solid antenna 21e and the fourth solid antenna 21f are the same as or substantially symmetrical to the first solid antenna 21c in shape and structure. In one embodiment, the third solid antenna 21e comprises a third solid radiator 21e2, a third connection section 21e1, and a third feed line, the fourth solid antenna 21f comprises a fourth solid radiator 21f2, a fourth connection section 21f1, and a fourth feed line.

A second plane antenna 22b, a third plane antenna 22c and a fourth plane antenna 22d are the same as or substantially symmetrical to the first plane antenna 22a in shape and structure. In one embodiment, all the plane antennas, such as 22a, 22b, 22c and 22d, are configured on the middle portions of different sidewalls of the shielding cover 30, respectively. The second plane antenna 22b comprises a second feed portion 22b1 and a second plane radiator 22b2. The third plane antenna 22c comprises a third feed portion 22c1 and a third plane radiator 22c2. The fourth plane antenna 22d comprises a fourth feed portion 22d1 and a fourth plane radiator 22d2.

In one embodiment, the shielding cover 30 further comprises a plurality of feed throughways, accepting passage therethrough of the feed portions of the plane antennas 22, and feed line of the solid antennas 21.

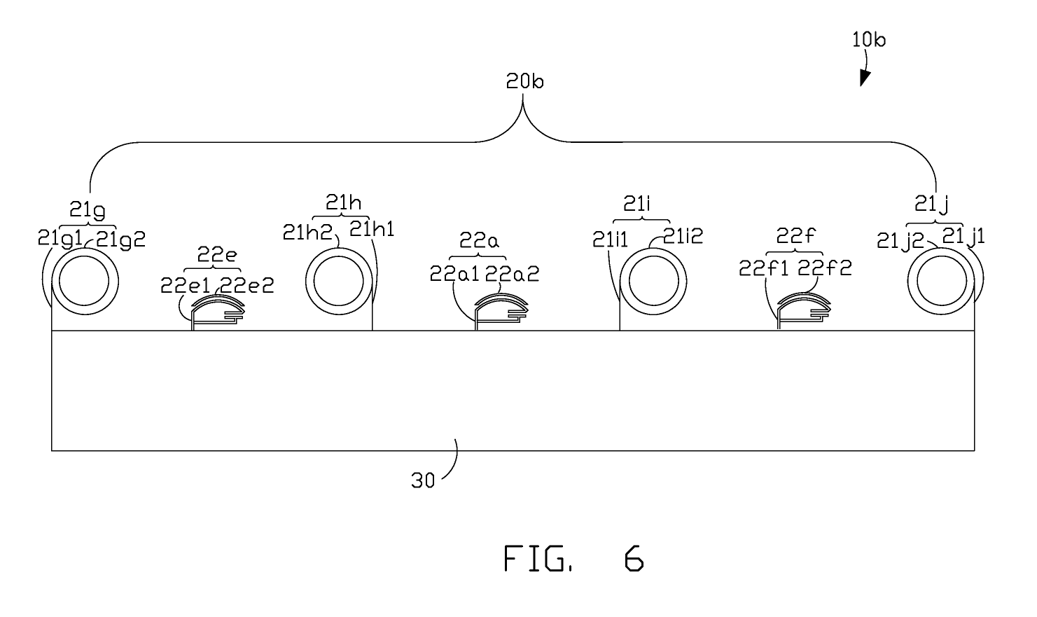

FIG. 6 is a schematic diagram of one embodiment of a MIMO device 10b according to the present disclosure, differing from the MIMO device 10 shown in FIG. 1 only in the further inclusion of a fifth solid antenna 21h, a sixth solid antenna 21i, a fifth plane antenna 22e, and a sixth plane antenna 22f. In one embodiment, the solid antennas 21 (g, h, i, j) and the plane antennas 22 (e, a, f) are configured on the same side of one sidewall of the shielding cover 30.

Referring to FIG. 3 and FIG. 6, the fifth solid antenna 21h and the sixth solid antenna 21i are the same as or substantially symmetrical to the first solid antenna 21g in shape and structure. The fifth solid antenna 21h comprises a fifth solid radiator 21h2, and a fifth connection section 21h1 and a fifth feed line. The sixth solid antenna 21i comprises a sixth solid radiator 21i2, a sixth connection section 21i1, and a sixth feed line.

The plurality of plane antennas 22, such as the fifth plane antenna 22e, and the sixth plane antenna 22f are the same as the first plane antenna 22a in shape and structure. The fifth plane antenna 22e comprises a fifth feed portion 22e1 and a fifth plane radiator 22e2. The sixth plane antenna 22f comprises a sixth feed portion 22f1 and a sixth plane radiator 22f2.

A first connection section 21g1, a second connection section 21j1, the fifth connection section 21h1, the sixth connection section 21i1, the first feed portion 22a1, a fifth feed portion 22e1, and a sixth feed portion 22f1 are perpendicular to the same sidewall of the shielding cover 30.

In one embodiment, the connecting portion 40 shown in FIG. 1 may be configured in any location, or the MIMO antenna 20 connected to the other elements directly, obviating the presence of the connecting portion 40 in FIG. 5 and FIG. 6.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A multiple-input multiple-output (MIMO) device, comprising:
a substrate;
a shielding cover, positioned on the substrate and comprising a plurality of sidewalls; and
a MIMO antenna, comprising:
a first solid antenna and a second solid antenna, electrically connected to two ends of one sidewall of the shielding cover, respectively; and
a first plane antenna configured on the substrate, and disposed between the first solid antenna and the second solid antenna.

2. The MIMO device as claimed in claim 1, wherein the first solid antenna comprises a first feed line, a first connection section and a first solid radiator, and wherein the first connection section comprises a first feed end and a first short end.

3. The MIMO device as claimed in claim 2, wherein the second solid antenna comprises a second feed line, a second connection section and a second solid radiator, and the second solid antenna is substantially symmetrical to the first solid antenna in shape and structure.

4. The MIMO device as claimed in claim 3, wherein the first solid radiator and the second solid radiator are annular.

5. The MIMO device as claimed in claim 3, wherein the first connection section and the second connection section are connected to the two ends of the one sidewall of the shielding cover, respectively.

6. The MIMO device as claimed in claim 5, wherein the first plane comprises a first plane radiator and a first feed portion.

7. The MIMO device as claimed in claim 6, wherein the first plane radiator is substantially G shaped.

8. The MIMO device as claimed in claim 7, wherein the shielding cover further comprises a first feed throughway, a second feed throughway, and a third feed throughway, configured on the two ends and middle portion of the sidewall of the shielding cover, respectively, for the first feed line, the second feed line and the first feed portion to pass through.

9. The MIMO device as claimed in claim 6, wherein the first solid antenna and the second solid antenna are configured on one side of the one sidewall of the shielding cover, and the first plane antenna is on the other side of the sidewall of the shielding cover.

10. The MIMO device as claimed in claim 6, wherein the first plane radiator is grounded by coupling to the one sidewall of the shielding cover.

11. The MIMO device as claimed in claim 6, wherein the MIMO antenna further comprises a third solid antenna and a fourth solid antenna, the third solid antenna comprises a third solid radiator, a third connection section, and a third feed line, the fourth solid antenna comprises a fourth solid radiator, a fourth connection section, and a fourth feed line.

12. The MIMO device as claimed in claim 11, wherein the third solid antenna and the fourth solid antenna are the same as or substantially symmetrical to the first solid antenna in shape and structure, and connect to two ends of another sidewall of the shielding cover, by the third connection section and the fourth connection section, respectively.

13. The MIMO device as claimed in claim 12, wherein the MIMO antenna comprises a plurality of plane antennas, the same as or substantially symmetrical to the first plane antenna in shape and structure, and are configured on middle portions of different sidewalls of the shielding cover, respectively.

14. The MIMO device as claimed in claim 13, wherein the first solid antenna, the second solid and the first plane antenna are configured on the same side of the one sidewall of the shielding cover, the third solid antenna, the fourth solid antenna and one of the plurality of plane antennas are configured on another sidewall of the shielding cover.

15. The MIMO device as claimed in claim 14, wherein the MIMO antenna comprises a fifth solid antenna and a sixth solid antenna, the fifth solid antenna comprises a fifth solid radiator, a fifth connection section and a fifth feed line, the sixth solid antenna comprises a sixth solid radiator, a sixth connection section, and a sixth feed line.

16. The MIMO device as claimed in claim 15, wherein the fifth solid antenna and the sixth solid antenna are the same as or substantially symmetrical to the first solid antenna in shape and structure, and configured on the same sidewall with the first solid antenna, the fifth feed line and the sixth feed line pass through corresponding feed throughways of the shielding cover.

17. The MIMO device as claimed in claim 16, wherein the MIMO antenna comprises a plurality of plane antennas, the plurality of plane antennas are the same as the first plane antenna in shape and structure, and configured on the same sidewall of the shielding cover with the first plane antenna, and pass through corresponding feed throughway of the shielding cover.

18. The MIMO device as claimed in claim 17, wherein the first connection section, the second connection section, the fifth connection section, and the sixth connection section are perpendicular to the one sidewall of the shielding cover.
